(19) United States
(12) Patent Application Publication
(10) Pub. No.: US 2026/0157442 A1
(43) Pub. Date: Jun. 11, 2026

(54) AEROSOL-GENERATING DEVICE

(71) Applicant: KT&G Corporation, Daejeon (KR)

(72) Inventors: Jueon PARK, Gyeonggi-do (KR); Younji SHIN, Seoul (KR); Jongsub LEE, Gyeonggi-do (KR); Hunil LIM, Seoul (KR); Hyungjin JUNG, Seoul (KR)

(73) Assignee: KT&G Corporation, Daejeon (KR)

(21) Appl. No.: 19/094,399

(22) Filed: Mar. 28, 2025

(30) Foreign Application Priority Data
Jun. 25, 2024 (KR) 10-2024-0082860
Aug. 27, 2024 (KR) 10-2024-0115297

(51) Int. Cl. A24F 40/465; A24F 40/20

(52) U.S. Cl. CPC A24F 40/465; A24F 40/20

(57) ABSTRACT

An aerosol-generating device is disclosed. The aerosol-generating device includes a body having an elongated insertion space formed therein, and a heater including an electrically conductive track formed by connecting a plurality of tracks to each other in parallel, the heater being configured to heat the insertion space. The plurality of tracks includes an inner track, and at least one outer track having both ends respectively connected to both ends of the inner track, the at least one outer track surrounding an outer side or an inner side of the inner track, and a width of the at least one inner track ranges from 0.40 mm to 0.44 mm.

### CROSS-REFERENCE TO THE RELATED APPLICATION

This application claims priority from Korean Patent Application No. 10-2024-0082860, filed on Jun. 25, 2024, and Korean Patent Application No. 10-2024-0115297, filed on Aug. 27, 2024, in the Korean Intellectual Property Office, the disclosure of which is incorporated herein by reference in its entirety.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

A heater including a plurality of heating tracks may be used in an aerosol-generating device. Even if the same power is applied to a heater, a heating track located inside the heater may be heated to a higher temperature than that of other tracks. In this case, a hot spot may be generated in the heating track located inside the heater. Accordingly, since a portion of an aerosol-generating substance, which is adjacent to the hot spot, is heated to a higher temperature than that of the other portions of the aerosol-generating substance, there is a problem in that the aerosol-generating substance is not heated uniformly.

Furthermore, a portion of a support structure supporting the heater, which is adjacent to the hot spot, is heated to a higher temperature than that of the other portions of the support structure. As a result, there is a problem in that deformation occurs in some regions of the support structure.

### SUMMARY OF THE DISCLOSURE

It is an object of the present disclosure to solve the above and other problems. It is another object of the present disclosure to provide an aerosol-generating device including an electrically conductive track having a plurality of tracks provided thereon, and an inner track among the plurality of tracks has a width within a specific range.

It is still another object of the present disclosure to provide an aerosol-generating device in which the width of an outer track of an electrically conductive track is wider than the width of an inner track thereof.

It is still another object of the present disclosure to provide an aerosol-generating device including a support tube configured to support an outer side of an electrically conductive track, and the support tube has a thickness within a specific range.

It is still another object of the present disclosure to provide an aerosol-generating device including a heat-insulating member and a heat-dissipating member surrounding the outer side of a heater.

It is still another object of the present disclosure to provide an aerosol-generating device having an air gap formed between a heater and a heat-insulating member surrounding the outer side of the heater.

It is still another object of the present disclosure to provide an aerosol-generating device including an introduction passage configured for outside air to be introduced therethrough and disposed in a heat-insulating member.

In accordance with an aspect of the present disclosure for accomplishing the above objects, there is provided an aerosol-generating device including a body having an elongated insertion space formed therein, and a heater including an electrically conductive track formed by connecting a plurality of tracks to each other in parallel, the heater being configured to heat the insertion space, wherein the plurality of tracks includes at least one inner track and at least one outer track having both ends respectively connected to both ends of the inner track, the at least one outer track surrounding an outer side or an inner side of the inner track, and a width of the at least one inner track ranges from 0.40 mm to 0.44 mm.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment;

FIGS. 2 and 3 are views each showing the aerosol-generating device according to the embodiment of the present disclosure;

FIG. 4 is a front perspective view of the aerosol-generating device according to the embodiment of the present disclosure;

FIG. 5 is a view showing an electrically conductive track of a heater according to the embodiment of the present disclosure;

FIG. 6 is a view showing a coupling structure of the heater according to the embodiment of the present disclosure;

FIG. 7 is a cross-sectional view of the aerosol-generating device according to the embodiment of the present disclosure when viewed from the side surface thereof; and

FIG. 8 is a cross-sectional view of the aerosol-generating device according to the embodiment of the present disclosure when viewed from above.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic”, “logic block”, “part”, or “circuitry”. A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between semi-permanent storage of data in the storage medium and temporary storage of data stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

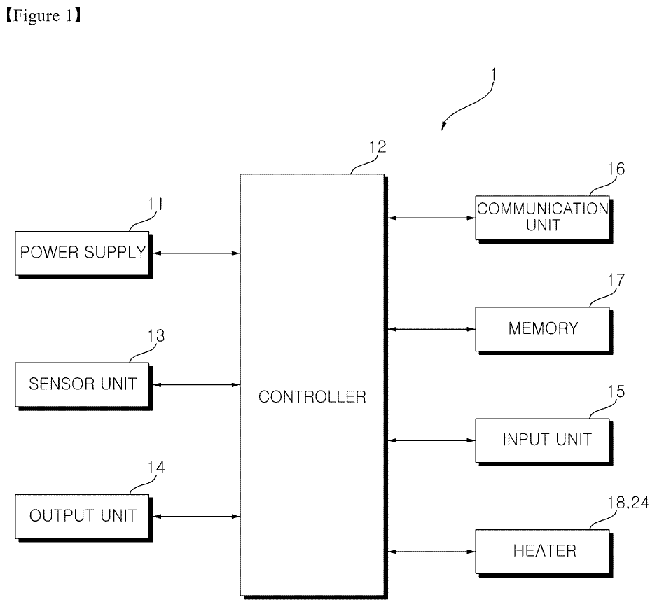

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change of the aerosol-generating article in the insertion space and/or aerosol flow may occur, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor May detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern. According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

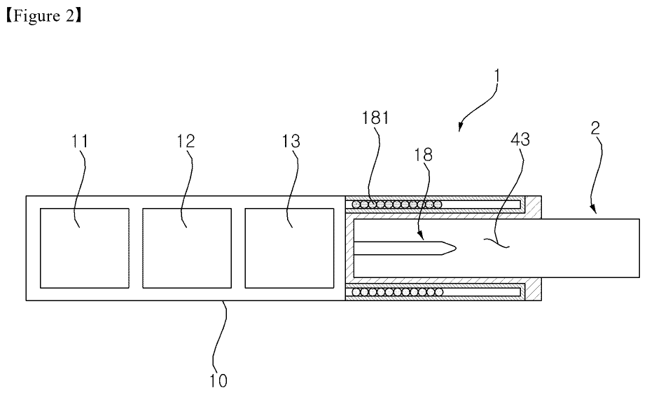

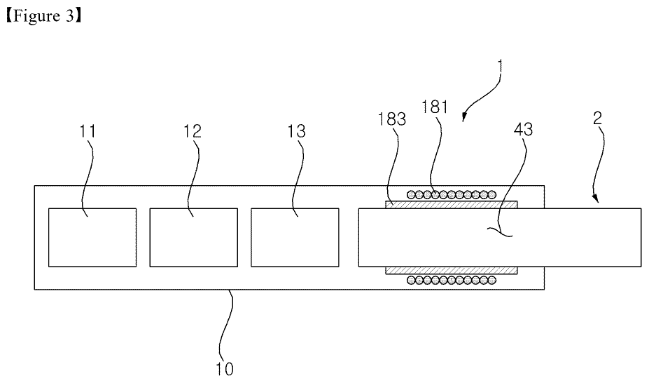

FIGS. 2 and 3 are views each showing the aerosol-generating device 1 according to the embodiment of the present disclosure.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. #a or FIG. #b and that some of the components may be omitted or new components may be further included. The aerosol-generating device 1 shown in FIG. 2 may be referred to as an “internal heating-type” aerosol-generating device that heats the inner side of an aerosol-generating article 2. The aerosol-generating device 1 shown in FIG. 3 may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 3, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) including a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2 will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2 or FIG. 3, both the heater 182 in FIG. 2 and the heater 183 in FIG. 3 may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

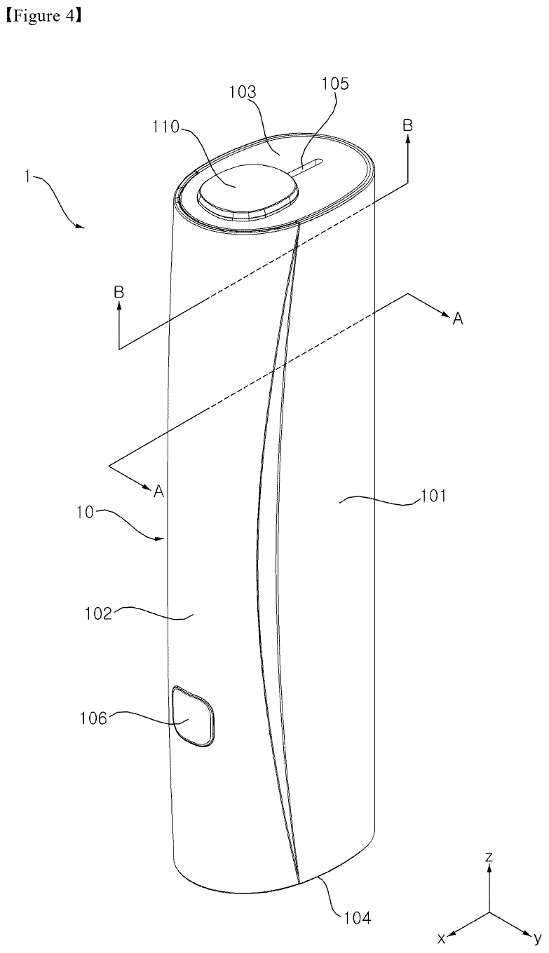

FIG. 4 is a front perspective view of an aerosol-generating device according to one embodiment of the present disclosure.

Referring to FIG. 4, a body 10 (e.g., the housing 10 in FIGS. 2 and 3) may include side walls 101 and 102 that extend lengthwise, a cover 103 that forms one end of the body 10, a base 104 that forms the other end of the body 10, and a door 110 that opens and close an insertion space 43. The body 10 may have a cylindrical shape that extends in one direction.

The body 10 may include the side walls 101 and 102 that form the outer surface of the body 10. The side walls 101 and 102 may include a curved surface extending in the circumferential direction of the body 10.

The side walls 101 and 102 may include a first side wall 101. The first side wall 101 may extend in the circumferential direction of the body 10. The first side wall 101 may be bent in the circumferential direction of the body 10 and form a space therein. The first side wall 101 may have one side that is opened. The cross-section of the first side wall 101 may have a loop shape with one side that is opened.

The side walls 101 and 102 may include a second side wall 102. The second side wall 102 may extend in the longitudinal direction of the body 10. The second side wall 102 may be coupled to the first side wall 101. The second side wall 102 may be located between both ends of the first side wall 101 in the circumferential direction, and form a surface that is continuous with the first side wall 101. The second side wall 102 may cover one side of the first side wall 101 that is opened laterally.

The body 10 may include the cover 103 that forms one end of the body 10 in the longitudinal direction. The cover 103 may be coupled to one end of the first side wall 101 in the longitudinal direction and one end of the second side wall 102 in the longitudinal direction.

The body 10 may include the door 110. The door 110 may be coupled to the cover 103. The door 110 may open and close the insertion space 43 (see FIGS. 2 and 3) in a sliding manner. A rail 105 may be formed on the cover 103. The door 110 may slide along the rail 105.

The body 10 may include the base 104 that forms the other end of the body 10 in the longitudinal direction. The base 104 may be coupled to the other end of the first side wall 101 in the longitudinal direction and the other end of the second side wall 102 in the longitudinal direction.

A button 106 (e.g., the input unit 15 in FIG. 1) may be provided on the body 10. The button 106 may be inserted into a hole formed in one side of the second side wall 102.

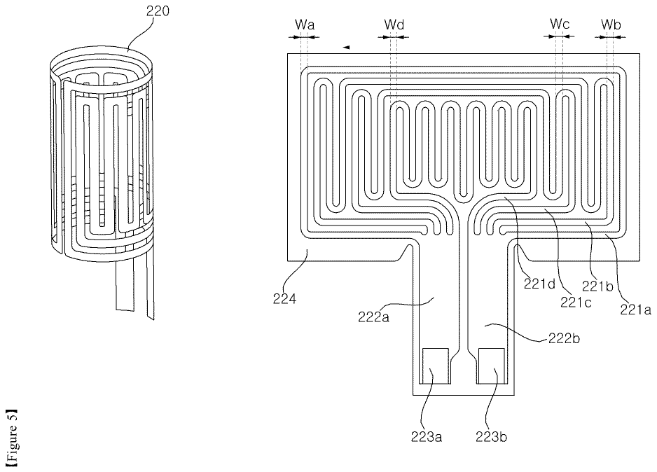

FIG. 5 is a view showing an electrically conductive track 220 of the heater 18 according to the embodiment of the present disclosure.

Referring to FIG. 5, the heater 18 may include the electrically conductive track 220. The electrically conductive track 220 may have a cylindrical shape. The electrically conductive track 220 may generate heat by receiving power from the power supply 11. The electrically conductive track 220 may be referred to as a heating element. Heat generated from the electrically conductive track 220 may heat a medium and/or a moisturizer of the stick 2 (refer to FIGS. 2 and 3) inserted into the insertion space 43, thereby generating an aerosol. The electrically conductive track 220 may be formed by etching a metal thin film with laser light. The electrically conductive track 220 may be made of stainless steel, copper, aluminum, or an alloy, but the present disclosure is not limited thereto.

The electrically conductive track 220 may include a heating track 221 and a connection part 222. The heating track 221 may include at least one of tracks 221a, 221b, 221c, and 221d connected to each other in parallel. The heating track 221 may be divided into inner tracks 221b and 221c and outer tracks 221a and 221d. The inner tracks 221b and 221c may include at least one of a second track 221b or a third track 221c.

The outer tracks 221a and 221d may include at least one of a first track 221a or a fourth track 221d.

The first track 221a may be disposed at the outermost side of the electrically conductive track 220 and may have a rectangular shape overall. The first track 221a may surround at least a portion of the outer side of the second track 221b. The second track 221b may surround at least a portion of the outer side of the third track 221c. The third track 221c may surround at least a portion of the outer side of the fourth track 221d.

The first track 221a may surround at least a portion of the outer side of the second track 221b. The fourth track 221d may surround at least a portion of the inner side of the third track 221d. In other words, the outer tracks 221a and 221d may surround the outer side or the inner side of the inner tracks 221b and 221c.

The first to fourth tracks 221a, 221b, 221c, and 221d may include at least one bent portion and may have a curved shape. The first to fourth tracks 221a, 221b, 221c, and 221d may be spaced apart from each other. The first to fourth tracks 221a, 221b, 221c, and 221d may each have one end connected to the other and the other ends connected to each other. In other words, the first to fourth tracks 221a, 221b, 221c, and 221d may be connected to each other in parallel.

A width Wa of the first track 221a may be substantially the same as a width Wd of the fourth track 221d. At least one of a width Wb of the second track 221a or a width Wc of the third track 221c may be smaller than the width Wa of the first track 221a. In other words, the width of at least one of the outer tracks 221a and 221d may be wider than the width of at least one of the inner tracks 221b and 221c.

The width of each of the first to fourth tracks 221a, 221b, 221c, and 221d may be wider than an interval between the tracks adjacent to each other among the first to fourth tracks. Accordingly, a heating area of the electrically conductive track 220 may be increased, and the insertion space 43 or the stick 2 inserted into the insertion space 43 may be uniformly heated by the electrically conductive track 220.

The connection part 222 may protrude outwards from one side of the heating track 221. The connection part 222 may be formed to be integrated with the heating track 221. The connection part 222 may be exposed from an insulator (not shown) covering the electrically conductive track 220. The connection part 222 may include a first connection part 222a and a second connection part 222b. The first connection part 222a may be connected to one end of each of the first to fourth tracks 221a, 221b, 221c, and 221d, and the second connection part 222b may be connected to the other end of each of the first to fourth tracks 221a, 221b, 221c, and 221d.

A lead 223 may be connected to the electrically conductive track 220. The lead 223 may be connected to the connection part 222. The lead 223 may be elongated in a direction in which the connection part 222 protrudes. The lead 223 may electrically connect the electrically conductive track 220 to the power supply 11. The lead 223 may include a first lead 223a contacting the first connection part 222a and a second lead 223b contacting the second connection part 222b. Power may be supplied to the electrically conductive track 220 through the first lead 223a and the second lead 223b. The lead 223 may be attached to the connection part 222 by welding. However, a method of attaching the lead 223 to the connection part 222 is not limited thereto.

At least one of the inner tracks 221b and 221c may have a width within a specific range. For example, at least one of the width Wb of the second track 221a or the width Wc of the third track 221c may range from 0.40 mm to 0.44 mm. For example, at least one of the width Wb of the second track 221a or the width Wc of the third track 221c may range from 0.41 mm to 0.43 mm. For example, at least one of the width Wb of the second track 221a or the width Wc of the third track 221c may be about 0.42 mm.

At least one of the outer tracks 221a and 221d may have a width within a specific range. For example, at least one of the width Wa of the first track 221a or the width Wd of the fourth track 221d may range from 0.43 mm to 0.47 mm. For example, at least one of the width Wa of the first track 221a or the width Wd of the fourth track 221d may range from 0.44 mm to 0.46 mm. For example, at least one of the width Wa of the first track 221a or the width Wd of the fourth track 221d may be about 0.45 mm.

The width of at least one of the outer tracks 221a and 221d may be wider than the width of at least one of the inner tracks 221b and 221c. A resistance value of at least one of the outer tracks 221a and 221d may be smaller than a resistance value of at least one of the inner tracks 221b and 221c. In a state in which the same power is applied to both ends of the track, a value of current flowing through a track having a large resistance value among a plurality of tracks connected to each other in parallel may be smaller than a value of current flowing through a track having a small resistance value among the plurality of tracks. A value of current flowing through the inner track may be smaller than a value of current flowing through the outer track, and a heating temperature difference between the inner track and the outer track may be reduced.

The following Table 1 shows the results of comparison between the maximum temperatures of the electrically conductive track depending on the width of the inner track.

In Table 1, the maximum temperature indicates the highest temperature among a plurality of points of the inner track and the highest temperature among a plurality of points of the outer track in a state in which predetermined power is applied to the electrically conductive track.

TABLE 1

| | |
|---|---|
| Width (mm) | Maximum temperature (° C.) |

| Inner track | Outer track | Inner track | Outer track |
|---|---|---|---|
| 0.42 | 0.45 | 300 | 275 |
| 0.45 | 0.45 | 357 | 276 |

In a heater in which each of the inner track and the outer track has a width of 0.45 mm, the measured maximum temperature of the inner track was 357° C., and the measured maximum temperature of the outer track was 276° C. As a result, a difference between the measured maximum temperatures of the inner track and the outer track was 81° C.

In contrast, in a heater in which the inner track has a width of 0.42 mm and the outer track has a width of 0.45 mm, the maximum measured temperature of the inner track was 300° C., and the measured maximum temperature of the outer track was 276° C. As a result, a difference between the measured maximum temperatures of the inner track and the outer track was 25° C.

In this manner, when the inner track has a smaller width than that of the outer track and the inner track has a width within a specific range, it may be confirmed that the maximum temperature of the outer track is maintained at substantially the same level, and the maximum temperature of the inner track is reduced by more than 50° C. Accordingly, it may be confirmed that a temperature difference between the inner track and the outer track is also significantly reduced from 81° C. to 25° C.

As described above, the electrically conductive track according to the embodiment of the present disclosure makes it possible not only to suppress the occurrence of a hot spot, but also to reduce a heating temperature difference between a plurality of tracks. Accordingly, an aerosol-generating substance may be heated more uniformly by a heater.

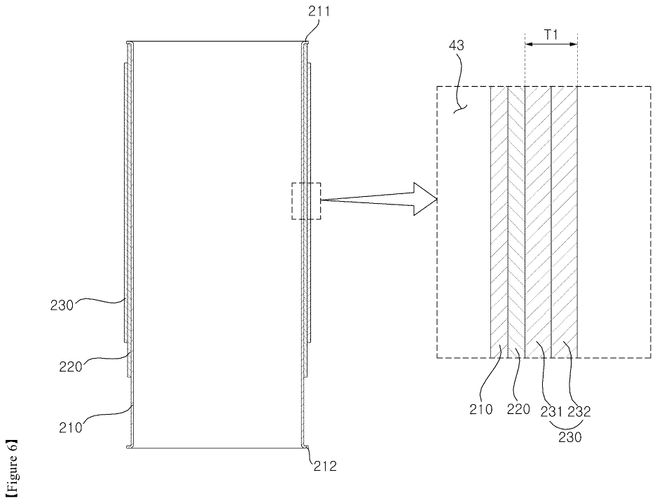

FIG. 6 is a view showing a coupling structure of the heater according to the embodiment of the present disclosure.

Referring to FIG. 6, the heater 18 may include a susceptor 210, the electrically conductive track 220, and a support tube 230. The heater 18 may be referred to as a heater assembly.

The susceptor 210 may have a cylindrical shape. The susceptor 210 may be located at the innermost side of the hollow heater 18. The susceptor 210 may be disposed on the inner side of the electrically conductive track 220. The susceptor 210 may surround at least a portion of the insertion space 43. At least a portion of the inner surface of the susceptor 210 may contact the outer circumferential surface of the stick 2 inserted into the insertion space 43. The susceptor 210 may be referred to as a heat transfer element, a heat conduction part, a heat diffusion part, or a pipe. The susceptor 210 may be made of stainless steel, aluminum, or an alloy, but the present disclosure is not limited thereto.

In the longitudinal direction of the susceptor 210 or the longitudinal direction of the insertion space 43, the upper end or one end 211 and the lower end or the other end 212 of the susceptor 210 may be bent outwards. The one end 211 and the other end 212 of the susceptor 210 may each have a flange shape bent outwards in the radial direction of the susceptor 210.

Accordingly, since flange shapes are respectively provided at both ends of the susceptor 210, strength of the susceptor 210 may be increased, thereby preventing deformation of the susceptor 210 during the process of heating or cooling the susceptor 210.

The electrically conductive track 220 may have a cylindrical shape. The electrically conductive track 220 may be disposed outside the susceptor 210. The electrically conductive track 220 may surround at least a portion of the susceptor 210. In the longitudinal direction of the insertion space 43, the electrically conductive track 220 may be aligned with the upper end 211 of the susceptor 210. For example, the upper end of the electrically conductive track 220 may be in contact with the upper end 211 of the susceptor 210, which protrudes in a flange shape. The length of the electrically conductive track 220 may be shorter than the length of the susceptor 210. The lower end of the electrically conductive track 220 may be spaced apart from the lower end 212 of the susceptor 210 in the upward direction.

An insulator (not shown) may be disposed on one side of the electrically conductive track 220. The insulator may be disposed on the inner and/or outer side of the electrically conductive track 220 and may have a cylindrical shape. The insulator may cover the electrically conductive track. In the longitudinal direction of the insertion space 43, the insulator may extend farther upwards and downwards than the electrically conductive track 220. In the radial direction of the insertion space 43, the insulator may be disposed between the susceptor 210 and the electrically conductive track 220.

The insulator may be formed of a material having flexibility and heat resistance. The insulator may include polyimide or polyetheretherketone (PEEK), but the present disclosure is not limited thereto. The insulator may include other materials having elasticity, heat resistance, and electrical insulation.

The support tube 230 may have a cylindrical shape. The support tube 230 may be disposed outside the electrically conductive track 220. The support tube 230 may surround at least a portion of the outer side of the electrically conductive track 220. In the longitudinal direction of the insertion space 43, the support tube 230 may be disposed between both ends of the electrically conductive track 220. The length of the support tube 230 may be shorter than the length of each of the susceptor 210 and the electrically conductive track 220.

The support tube 230 may be formed of a material having flexibility and heat resistance. The support tube 230 may include at least one of polyetheretherketone (PEEK) or polytetrafluoroethylene (PTFE).

The support tube 230 may have a thickness in a specific range. For example, a thickness T1 of the support tube 230 may range from 0.15 mm to 0.25 mm. For example, the thickness T1 of the support tube 230 may range from 0.175 mm to 0.225 mm. For example, the thickness T1 of the support tube 230 may be about 0.2 mm.

The support tube 230 may include a plurality of layers 231 and 232 surrounding the outer side of the electrically conductive track 220. For example, the support tube 230 may include a first layer 231 that contacts the outer side of the electrically conductive track 220 and a second layer 232 that contacts the first layer 231 and surrounds the outer side of the first layer 231. The first layer 231 and the second layer 232 may have substantially the same thickness.

The support tube 230 may include a heat shrinkable material. The support tube 230 may be disposed to surround the outer side of the electrically conductive track 220 during the manufacturing process of the heater 18, and may shrink while being heated to a set temperature so as to adhere to the outer side of the electrically conductive track 220.

Even if the support tube 230 has the same thickness in the shrinkage state, the support tube 230 formed of a plurality of layers may be more uniformly compressed on the outer side of the electrically conductive track 220 than the support tube 230 formed of a single layer. In addition, a plurality of layers each having a relatively thin thickness may be more easily shrunk by heat than a single layer having a thick thickness.

Table 2 below shows the results of comparison between the deformation temperatures of the support tube 230 depending on the thickness and material of the support tube 230. Here, the thickness of the support tube 230 is 0.2 mm, which means that two layers each having a thickness of 0.1 mm are formed to be stacked.

In Table 2, the deformation temperature represents a temperature at which at least a portion of the support tube 230 begins to be deformed as the electrically conductive track 220 generates heat.

TABLE 2

| Tube material | Thickness (mm) | Deformation temperature (° C.) |
|---|---|---|
| PEEK | 0.1 | 280 |
| PEEK | 0.2 | 315 |

In the support tube 230 made of polyetheretherketone, when the thickness is 0.1 mm, deformation occurs in the support tube 230 at the temperature of about 280° C. In contrast, when the thickness of the support tube 230 is 0.2 mm, deformation occurs in the support tube 230 at the temperature of about 315° C.

As described above, it may be confirmed that, when the support tube 230 has a thickness of 0.2 mm or has a thickness within a certain range from 0.2 mm, deformation of the support tube 230 occurs at a temperature about 35° C. higher than a temperature of 280° C.

As shown in Table 1, the maximum temperature of the electrically conductive track 220 may rise to 300° C. Therefore, when the support tube 230 has a thickness of 0.2 mm or has a thickness within a certain range from 0.2 mm, even if some tracks of the electrically conductive track 220 rise to a high temperature, deformation of the support tube 230 does not occur, and heat generated from the electrically conductive track 220 may be effectively diffused or insulated by the support tube 230.

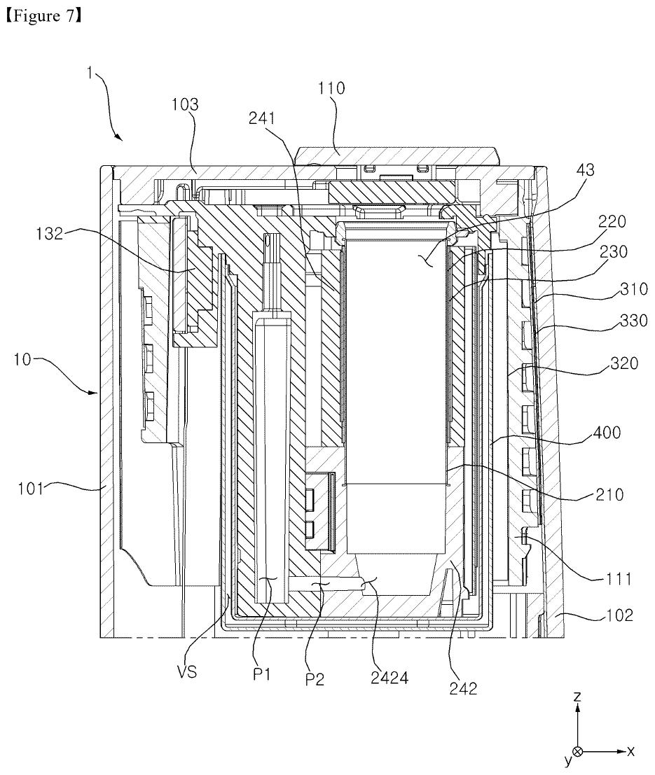

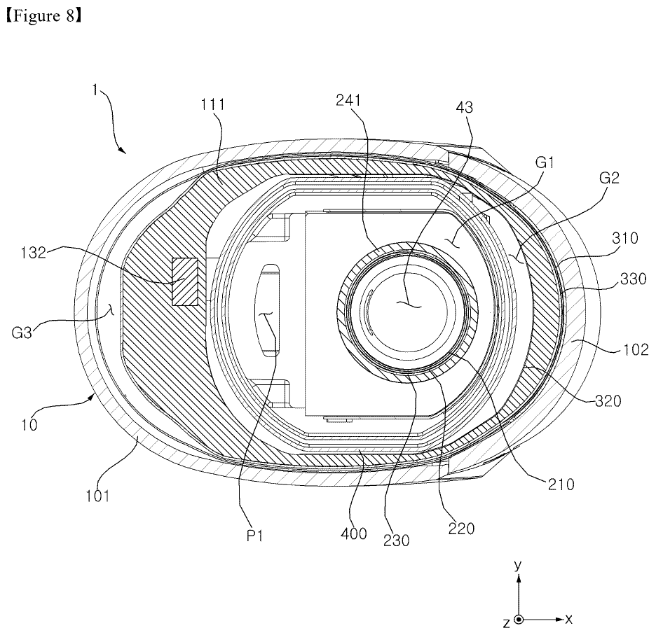

FIG. 7 is a cross-sectional view of the aerosol-generating device according to the embodiment of the present disclosure when viewed from the side surface thereof, and FIG. 8 is a cross-sectional view of the aerosol-generating device according to the embodiment of the present disclosure when viewed from above. FIG. 7 is a view showing a cross section of a body taken along line A-A in FIG. 4, and FIG. 8 is a view showing a cross section of the body taken along line B-B in FIG. 4.

Referring to FIGS. 7 and 8, the heater 18 may surround the insertion space 43. The heater 18 may be formed in a cylindrical shape having a hollow formed therein. At least a portion of the insertion space 43 may be formed in the heater 18.

A body casing 111 may be disposed inside the body 10. The body casing 111 may support the body 10 at the inside of the body 10. At least a portion of the body casing 111 may be coupled to or in contact with the inner surface of the body 10. The body casing 111 may accommodate the heater 18 therein.

The heater 18 may be coupled to heater casings 241 and 242. The heater 18 and the heater casings 241 and 242 may be accommodated in the inner space of the body casing 111. The heater casings 241 and 242 may surround the exterior of the heater 18. The heater casings 241 and 242 may include a first heater casing 241 and a second heater casing 242. The first heater casing 241 may surround a portion of the side surface of the heater 18. The second heater casing 242 may surround the remaining portion of the side surface of the heater 18. For example, the first heater casing 241 may surround the upper side surface of the heater 18, and the second heater casing 242 may surround the lower side surface of the heater 18.

The aerosol-generating device 1 may include at least one of a heat-insulating member 400 or a heat-dissipating member 300. The heat-insulating member 400 may be disposed inside the body 10. The heat-insulating member 400 may surround the exterior of the heater 18 at the inside of the body 10. The heat-insulating member 400 may thermally insulate the heater 18. The upper portion of the heat-insulating member 400 may be open. The heat-insulating member 400 may have a bottom formed at the lower portion thereof, and the bottom may have a hole formed in a portion thereof. The heat-insulating member 400 may be disposed to surround the side portion and the lower portion of the heater 18. The heat-insulating member 400 may include two layers. The inner layer and the outer layer of the heat-insulating member may be spaced apart from each other and may have a space VS formed therebetween. The space VS formed between the layers of the heat-insulating member 400 may be sealed from the outside. The space VS formed between the layers of the heat-insulating member 400 may be in a vacuum state. The heat-insulating member 400 may be referred to as a vacuum tube.

Accordingly, heat generated by the heater 18 may be minimally transferred to the outer circumferential surface of the body 10 by the heat-insulating member 400. Even if the heater 18 generates heat such that the temperature of the heater 18 rises to a high temperature, the heat-insulating member 400 may prevent heat having a high temperature from being transferred to the body of a user holding the body 10.

Introduction passages P1 and P2 may be formed inside the body casing 111. The introduction passages P1 and P2 may communicate with the outside of the body 10 and the insertion space 43. The introduction passages P1 and P2 may communicate with the insertion space 43 through an introduction hole 2424 formed in the second heater casing 242.

The introduction passages P1 and P2 may include a first introduction passage P1 and a second introduction passage P2. The second introduction passage P2 may communicate with the insertion space 43. The second introduction passage P2 may extend from the lower side of the insertion space 43 in a direction intersecting the longitudinal direction of the insertion space 43. The first introduction passage P1 may communicate with the second introduction passage P2. The first introduction passage P1 may extend from one end of the second introduction passage P2 in the longitudinal direction of the insertion space 43. The first introduction passage P1 may communicate with the outside of the body casing 111. The outside air of the aerosol-generating device 1 may be introduced into the body 10 through a gap provided in the body 10, may pass through the first introduction passage P1 and the second introduction passage P2, and may be introduced into the insertion space 43 through the introduction hole 2424.

A puff sensor 132 may be disposed on one side of the introduction passages P1 and P2. The puff sensor 132 may output a signal corresponding to the internal pressure or internal pressure change of the introduction passages P1 and P2. The puff sensor 132 may output a signal corresponding to a puff by a user. The puff sensor 132 may communicate with the introduction passages P1 and P2 and the insertion space 43. The puff sensor 132 may be disposed to face the introduction passages P1 and P2. In the radial direction of the insertion space 43, the puff sensor 132 may be disposed outside the heat-insulating member 400.

The introduction passages P1 and P2 may be disposed adjacent to the heater 18 at the inside of the body casing 111. The first introduction passage P1 may be disposed adjacent to the heater casings 241 and 242. At least a portion of the introduction passages P1 and P2 may be disposed inside the heat-insulating member 400. The heat-insulating member 400 may surround at least a portion of the outer side of each of the introduction passages P1 and P2.

The outside air introduced through the introduction passages P1 and P2 may be heated by heat generated from the heater 18. The outside air heated in the introduction passages P1 and P2 may be introduced into the insertion space 43 and may flow into the inside of the stick 2 through one end of the stick 2 accommodated in the insertion space 43.

In this manner, the introduction passages P1 and P2 are disposed in the heat-insulating member 400, and the outside air introduced into the insertion space 43 may be effectively heated.

In addition, the puff sensor 132 is disposed outside the heat-insulating member 400, thereby minimizing heating of the puff sensor 132 by heat generated from the heater 18.

In the radial direction of the insertion space 43, an air gap G1 may be formed between the heater casings 241 and 242 and the heat-insulating member 400. The gap may be referred to as a first gap. The first gap G1 may extend from the outer side of the heater 18 along the circumference of the heater 18.

Accordingly, heat generated from the heater 18 may be maximally prevented from being dissipated to the outside of the heater 18.

The heat-dissipating member 300 may include a first heat-dissipating member 310. The first heat-dissipating member 310 may be disposed inside the body 10. The first heat-dissipating member 310 may surround the exterior of the body casing 111 coupled to the body 10 at the inside of the body 10. The body casing 111 may have an accommodation part provided therein and formed by recessing a portion of an outer surface thereof along the outer circumference. The first heat-dissipating member 310 may be accommodated in the accommodation part of the body casing 111 and may surround the exterior of the body casing 111.

The first heat-dissipating member 310 may be disposed outside the heater 18 in the radial direction of the insertion space 43. The first heat-dissipating member 310 may surround at least a portion of the exterior of the heater 18. The first heat-dissipating member 310 may be disposed to be spaced apart from the heater 18 in the radial direction of the insertion space 43. The first heat-dissipating member 310 may extend longer than the heater 18 in the longitudinal direction of the insertion space 43. In the longitudinal direction of the insertion space 43, the upper end of the first heat-dissipating member 310 may be disposed at a higher location than the upper end of the heat-insulating member 400, and the lower end of the first heat-dissipating member 310 may be disposed at a lower location than the lower end of the heat-insulating member 400. The first heat-dissipating member 310 may be disposed outside the heat-insulating member 400. In the radial direction of the insertion space 43, the heat-insulating member 400 may be disposed between the heater 18 and the first heat-dissipating member 310.

The first heat-dissipating member 310 may include a material having excellent heat absorption and heat dissipation capabilities. For example, the first heat-dissipating member 310 may include at least one of graphite, a metal compound, or an aerogel.

Accordingly, heat generated from the heater 18 is maximally prevented from being transferred to the outer circumferential surface of the body 10 by the heat-insulating member 400 and the air gap G1, and even if a portion of the heat is transferred to the body 10, the transferred heat may be uniformly diffused into a large area of the body 10 by the first heat-dissipating member 310.

The heat-dissipating member 300 may include a second heat-dissipating member 320. The second heat-dissipating member 320 may be disposed inside the body casing 111. The second heat-dissipating member 320 may be disposed in a space formed in the body casing 111. The second heat-dissipating member 320 may be disposed between the heat-insulating member 400 and the first heat-dissipating member 310 in the radial direction of the insertion space 43.

The second heat-dissipating member 320 may surround at least a portion of the exterior of the heater 18. The second heat-dissipating member 320 may surround at least a portion of the outer side of the heat-insulating member 400. The second heat-dissipating member 320 may contact at least a portion of the outer surface of the heat-insulating member 400.

The heat-dissipating member 300 may include a third heat-dissipating member 330. The third heat-dissipating member 330 may be disposed inside the first heat-dissipating member 310. The third heat-dissipating member 330 may surround the exterior of the body casing 111. The third heat-dissipating member 330 may contact at least a portion of the first heat-dissipating member 310. The third heat-dissipating member 330 may surround the outer side of the heater 18.

The second heat-dissipating member 320 and the third heat-dissipating member 330 may include a material having excellent heat absorption and heat dissipation capabilities. For example, the second heat-dissipating member 320 and the third heat-dissipating member 330 may include at least one of graphite, a metal compound, or an aerogel.

An air gap G2 may be formed between the second heat-dissipating member 320 and the heat-insulating member 400. The gap may be referred to as a second gap. The second gap G2 may be located outside the first gap G1.

An air gap G3 may be formed between the first heat-dissipating member 310 and the third heat-dissipating member 330. The gap may be referred to as a third gap. The third gap G3 may be located outside the first gap G1.

In the radial direction of the insertion space 43, the second gap G2 and the third gap G3 may be disposed opposite to each other. The second gap G2 may be disposed to face the third gap G3 with the insertion space 43 interposed therebetween. For example, the second gap G2 may be located on the left side of the body 10 at the inside of the body 10, and the third gap G3 may be located on the right side of the body 10 at the inside of the body 10. The heat-insulating member 400 and the first gap G1 may be disposed between the second gap G2 and the third gap G3.

As described above, the first gap G1, the heat-insulating member 400, the first to third heat-dissipating members 310, 320, and 330, the second gap G2, and the third gap G3 are disposed outside the heater 18, thereby maximally preventing heat generated from the heater 18 from being transferred to the outside of the heater 18. Further, the heat may be prevented from being concentrated on a specific portion of the body 10.

As described above, according to at least one of the embodiments of the present disclosure, an inner track among a plurality of tracks provided on an electrically conductive track has a width within a specific range, thereby reducing a heating temperature difference between the plurality of tracks and preventing the occurrence of a hot spot.

According to at least one of the embodiments of the present disclosure, since the width of an outer track of the electrically conductive track is wider than the width of the inner track, a value of current flowing through the inner track may be smaller than a value of current flowing through the outer track, and a heating temperature difference between the inner track and the outer track may be reduced.

According to at least one of the embodiments of the present disclosure, since a support tube supporting the outer side of the electrically conductive track has a thickness within a specific range, heat generated from the track may be effectively diffused by the support tube, thereby preventing the occurrence of a hot spot and suppressing the heat generated from the track from being transferred to the outer side of the track.

According to at least one of the embodiments of the present disclosure, a heat-insulating member and a heat-dissipating member surrounding the outer side of the heater are provided, thereby reducing heat transfer to the outer side of the heater and preventing the transferred heat from being concentrated on a specific portion.

According to at least one of the embodiments of the present disclosure, an air gap is formed between the heater and the heat-insulating member surrounding the outer side of the heater, thereby reducing heat transfer to the outer side of the heater and preventing the transferred heat from being concentrated on a specific area.

According to at least one of the embodiments of the present disclosure, an introduction passage is disposed in the heat-insulating member such that outside air introduced into an insertion space is heated.

Referring to FIGS. 1 to 8, an aerosol-generating device 1 in accordance with one aspect of the present disclosure may include a body 10 having an elongated insertion space 43 formed therein, and a heater 18 including an electrically conductive track 220 formed by connecting a plurality of tracks to each other in parallel, the heater being configured to heat the insertion space 43. The plurality of tracks may include at least one inner track 221b and 221c, and at least one outer track 221a and 221d having both ends respectively connected to both ends of the inner track 221b and 221c, the at least one outer track surrounding an outer side or an inner side of the inner track 221b and 221c, and a width of the at least one inner track 221b and 221c may range from 0.40 mm to 0.44 mm.

In addition, in accordance with another aspect of the present disclosure, the width of the at least one inner track 221b and 221c may range from 0.41 mm to 0.43 mm.

In addition, in accordance with another aspect of the present disclosure, a width of the at least one outer track 221a and 221d may be wider than the width of the at least one inner track 221b and 221c.

In addition, in accordance with another aspect of the present disclosure, the width of the outer track 221a and 221d may range from 0.43 mm to 0.47 mm.

In addition, in accordance with another aspect of the present disclosure, a resistance value of the at least one outer track 221a and 221d may be smaller than a resistance value of the at least one inner track 221b and 221c.

In addition, in accordance with another aspect of the present disclosure, the aerosol-generating device may further include a support tube 230 surrounding an outer side of the electrically conductive track 220, and a thickness of the support tube 230 may range from 0.15 mm to 0.25 mm.

In addition, in accordance with another aspect of the present disclosure, the support tube 230 may include a plurality of layers 231 and 232 surrounding the outer side of the electrically conductive track 220.

In addition, in accordance with another aspect of the present disclosure, the support tube 230 may include polyetheretherketone (PEEK) or polytetrafluoroethylene (PTFE).

In addition, in accordance with another aspect of the present disclosure, the aerosol-generating device may include a first heat-dissipating member 310 disposed in the body 10 and surrounding the heater 18, and the first heat-dissipating member 310 may extend longer than the heater 18 in a longitudinal direction of the insertion space 43.

In addition, in accordance with another aspect of the present disclosure, the aerosol-generating device may include a heat-insulating member 400 surrounding the heater 18, and the heat-insulating member 400 may be disposed between the heater 18 and the first heat-dissipating member 310 in a radial direction of the insertion space 43.

In addition, in accordance with another aspect of the present disclosure, the aerosol-generating device may include a second heat-dissipating member 320 disposed between the heat-insulating member 400 and the first heat-dissipating member 310 in the radial direction of the insertion space 43, the second heat-dissipating member 320 may surround at least a portion of an outer side of the heat-insulating member 400, and at least a portion of the second heat-dissipating member 320 may contact an outer surface of the heat-insulating member 400.

In addition, in accordance with another aspect of the present disclosure, the aerosol-generating device may include heater casings 241 and 242 disposed in the body 10 and surrounding an exterior of the heater 18, and an air gap G1 may be formed between the heater casings 241 and 242 and the heat-insulating member 400 in the radial direction of the insertion space 43.

In addition, in accordance with another aspect of the present disclosure, the aerosol-generating device may include an introduction passage P communicating with an exterior of the body 10 and the insertion space 43, and the introduction passage P may be disposed inside the heat-insulating member 400.

In addition, in accordance with another aspect of the present disclosure, the first heat-dissipating member 310 may include at least one of an aerogel, graphite, or a metal compound.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as restrictive in all respects but should be considered as illustrative. The scope of the present disclosure should be determined by reasonable interpretation of the appended claims, and all changes within the equivalent scope of the present disclosure are embraced within the scope of the present disclosure.

What is claimed is:

1. An aerosol-generating device comprising:
a body having an elongated insertion space formed therein; and
a heater comprising an electrically conductive track formed by connecting a plurality of tracks to each other in parallel, the heater being configured to heat the insertion space,
wherein the plurality of tracks comprises:
at least one inner track; and
at least one outer track having both ends respectively connected to both ends of the inner track, the at least one outer track surrounding an outer side or an inner side of the inner track, and
wherein a width of the at least one inner track ranges from 0.40 mm to 0.44 mm.

2. The aerosol-generating device according to claim 1, wherein the width of the at least one inner track ranges from 0.41 mm to 0.43 mm.

3. The aerosol-generating device according to claim 1, wherein a width of the at least one outer track is wider than the width of the at least one inner track.

4. The aerosol-generating device according to claim 3, wherein the width of the outer track ranges from 0.43 mm to 0.47 mm.

5. The aerosol-generating device according to claim 1, wherein a resistance value of the at least one outer track is smaller than a resistance value of the at least one inner track.

6. The aerosol-generating device according to claim 1, further comprising a support tube surrounding an outer side of the electrically conductive track,
wherein a thickness of the support tube ranges from 0.15 mm to 0.25 mm.

7. The aerosol-generating device according to claim 6, wherein the support tube comprises a plurality of layers surrounding the outer side of the electrically conductive track.

8. The aerosol-generating device according to claim 6, wherein the support tube comprises polyetheretherketone (PEEK) or polytetrafluoroethylene (PTFE).

9. The aerosol-generating device according to claim 1, comprising a first heat-dissipating member disposed in the body and surrounding the heater,
wherein the first heat-dissipating member extends longer than the heater in a longitudinal direction of the insertion space.

10. The aerosol-generating device according to claim 9, comprising a heat-insulating member surrounding the heater,
wherein the heat-insulating member is disposed between the heater and the first heat-dissipating member in a radial direction of the insertion space.

11. The aerosol-generating device according to claim 10, comprising a second heat-dissipating member disposed between the heat-insulating member and the first heat-dissipating member in the radial direction of the insertion space,
wherein the second heat-dissipating member surrounds at least a portion of an outer side of the heat-insulating member, and at least a portion of the second heat-dissipating member contacts an outer surface of the heat-insulating member.

12. The aerosol-generating device according to claim 10, comprising a heater casing disposed in the body and surrounding an exterior of the heater,
wherein an air gap is formed between the heater casing and the heat-insulating member in the radial direction of the insertion space.

13. The aerosol-generating device according to claim 10, comprising an introduction passage communicating with an exterior of the body and the insertion space,
wherein the introduction passage is disposed inside the heat-insulating member.

14. The aerosol-generating device according to claim 9, wherein the first heat-dissipating member comprises at least one of an aerogel, graphite, or a metal compound.
